(19) United States
(12) Patent Application Publication
(10) Pub. No.: US 2023/0386353 A1
(43) Pub. Date: Nov. 30, 2023

(54) SYSTEM FOR EDUCATION IN AUGMENTATION REALITY AND METHOD FOR THE SAME

(71) Applicant: Electronics and Telecommunications Research Institute, Daejeon (KR)

(72) Inventors: Sung Jin HONG, Daejeon (KR); Cho Rong YU, Daejeon (KR); Youn Hee GIL, Daejeon (KR); Seong Min BAEK, Daejeon (KR); Hee Sook SHIN, Daejeon (KR)

(73) Assignee: Electronics and Telecommunications Research Institute, Daejeon (KR)

(21) Appl. No.: 17/943,737

(22) Filed: Sep. 13, 2022

(30) Foreign Application Priority Data
May 26, 2022 (KR) 10-2022-0064547

(51) Int. Cl. G09B 5/06; G06T 19/00

(52) U.S. Cl. CPC G09B 5/065; G06T 19/006

(57) ABSTRACT

Provided is a system for education in augmented reality (AR) for technology education in AR, The system for education in AR includes an instructor terminal configured to, in order to guide training of at least one learner on site or remotely using AR content, identify a training process of the trainee and generate training support information, an AR service providing server configured to manage the instructor terminal and a learner terminal that participate in the training using the AR content based on a request of the instructor terminal, and at least one learner terminal configured to transmit content training information to the AR service providing server.

### CROSS-REFERENCE TO RELATED APPLICATION

This application claims priority to and the benefit of Korean Patent Application No. 10-2022-0064547, filed on May 26, 2022, the disclosure of which is incorporated herein by reference in its entirety.

### BACKGROUND

### 1. Field of the Invention

The present invention relates to a system for education in augmentation reality between an instructor and a learner, that is capable of being used for multi-user simultaneous education as an augmented reality (AR) service and a method for the same.

### 2. Discussion of Related Art

There has been growing attention on an education method using an augmented reality (hereinafter referred to as AR) service.

The education method using an AR service is considered more suitable for a case requiring a high cost of equipment to be used for education or having a high risk of education content, such as surgical practice in an operating room, anatomy practice, a test run in the automobile manufacturing field, automobile repair and maintenance education and training, and the like, and in particular, there is growing popularization of education systems using AR services in an educational environment in which an instructor and learners participate together.

However, the current education methods and systems using AR services are provided in a manner that mostly, in industries and manufacturing fields, an instructor serviced with a shared screen of a learner augments the screen with education and training-related content provided by the instructor on the learner's screen to render the screen, so it is difficult to accurately convey the intention to the learner, and in particular, a complex form of content related to education and training is even more difficult to be conveyed.

In addition, in the related art, when education is simultaneously provided to a plurality of learners, the instructor may provide feedback for each individual learner, but other learners need to wait for a long time to receive feedback. When a plurality of learners simultaneously receive feedback, information generated by the instructor in a bundle may only be delivered, so there is a limitation in providing a desired training effect to a group of learners with various specificities, such as specificities (a height and the like) of a learner or specificities (the position of a terminal, a field of view (FOV) of a terminal, etc.) of a device used by a learner.

### SUMMARY OF THE INVENTION

The present invention is directed to providing a system for education in augmentation reality (AR), that is capable of, when multiple users each including an instructor and a learner use AR content based on a mixed real and virtual environment in a training process, in order to provide a user customized guide for a virtual object, recognizing a training space to set a virtual object position and user position required for training, and a method for the same.

The technical objectives of the present invention are not limited to the above, and other objectives may become apparent to those of ordinary skill in the art based on the following description.

According to an aspect of the present invention, there is provided a system for education in augmented reality (AR), the system including: an instructor terminal configured to, in order to guide training of at least one learner on site or remotely using AR content, identify a training process of the trainee and generate training support information which is support information required for performing the training; an AR service providing server configured to manage the instructor terminal and a learner terminal that participate in the training using the AR content based on a request of the instructor terminal, and in order to derive a training space used in the training process, analyze a training space in which the instructor terminal is located and a training space in which the learner terminal is located; and at least one learner terminal configured to transmit, to the AR service providing server, content training information which is a result obtained by the learner performing the training based on the training support information.

According to another aspect of the present invention, there is provided a method of education in augmented reality (AR), the method including: analyzing, by an AR service providing server, a training space in which an instructor terminal is located and a training space in which a learner terminal is located; determining, by the AR service providing server, training execution start positions of the instructor terminal and the learner terminal based on a result of the analyzing of the training spaces; after the determining of the training execution start positions, generating, by the instructor terminal, training support information which is support information required for performing training on a learner, and transmitting the generated training support information to the AR service providing server; transmitting, by the AR service providing server, the received training support information to the learner terminal; and transmitting, by the learner terminal, content training information, which is a result obtained by the learner performing the training based on the training support information, to the AR service providing server, wherein the learner performs the training using the learner terminal.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating a system for education in augmentation reality according to an embodiment of the present invention;

FIG. 2 is a conceptual diagram illustrating a system for education in augmentation reality according to an embodiment of the present invention;

FIG. 3 is a flowchart showing a method of education in augmentation reality according to an embodiment of the present invention;

FIG. 4 is a flowchart showing a method of determining a start position in a method of education in augmentation reality according to an embodiment of the present invention;

FIG. 5 is a flowchart showing a method of generating recommended spatial area information in a method of education in augmentation reality according to an embodiment of the present invention;

FIG. 6 is a conceptual diagram illustrating setting of a variable training condition according to a state of a user in a method of education in augmentation reality according to an embodiment of the present invention;

FIG. 7A is a flowchart showing a method of correcting instructor training support information in a method of education in augmentation reality according to an embodiment of the present invention;

FIG. 7B is a flowchart showing a method of correcting instructor training support information in a method of education in augmentation reality according to an embodiment of the present invention; and

FIG. 8 is a diagram illustrating detailed functions of the system for education in augmentation reality shown in FIG. 1.

### DETAILED DESCRIPTION OF EXEMPLARY EMBODIMENTS

While the present invention is subject to various modifications and alternative embodiments, specific embodiments thereof are shown by way of example in the accompanying drawings and will be described. However, it should be understood that there is no intention to limit the present invention to the particular embodiments disclosed, but on the contrary, the present invention is to cover all modifications, equivalents, and alternatives falling within the spirit and scope of the present invention.

It will be understood that, although the terms first, second, etc. may be used herein to describe various elements, the elements should not be limited by the terms. The terms are only used to distinguish one element from another. For example, a first element could be termed a second element, and, similarly, a second element could be termed a first element without departing from the scope of the present invention. As used herein, the term “and/or” includes any one or combination of a plurality of the associated listed items.

It will be understood that when an element is referred to as being “connected” or “coupled” to another element, it can be directly connected or coupled to another element or intervening elements may be present. In contrast, when an element is referred to as being “directly connected” or “directly coupled” to another element, there are no intervening elements present.

The terminology used herein is for the purpose of describing particular embodiments only and is not intended to be limiting to the present invention. As used herein, the singular forms “a,” “an,” and “one” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components but do not preclude the presence or addition of one or more other features, integers, steps, operations, elements, components, and/or groups thereof.

Term “the aforementioned” and similar designations used in the present invention may indicate both singular and plural. In addition, unless clearly specified otherwise, the operations describing the method according to the present disclosure may be performed in an order to carry out the desired purpose. The present invention is not limited according to the described order of the operations.

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments of the present invention will be described with reference to the accompanying drawings in detail. For better understanding of the present invention, the same reference numerals are used to refer to the same elements through the description of the figures, and the description of the same elements will be omitted.

The present invention is directed to providing a system for education in an augmented reality (AR) and a method for the same that are capable of, when multiple users each including an instructor and a learner use AR content based on a mixed real and virtual environment in a training process, in order to provide a user customized guide for a virtual object, recognizing an education space to set a virtual object position and user position. That is, according to the present invention, while AR-based training content is used in a training process, when an instructor provides a plurality of learners with the same virtual object in an education process, the plurality of learners may be simultaneously provided with training content and customized guides suitable of the positions of the learners regardless of the type of the device used by the learner and the physical characteristics of the learner.

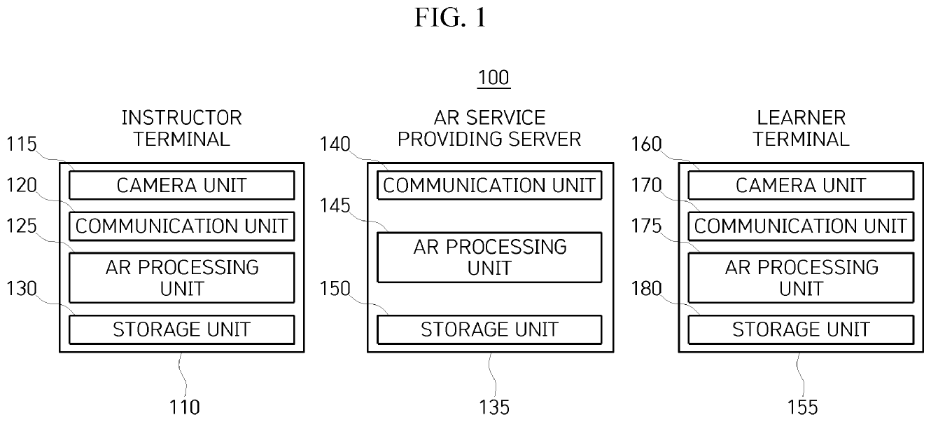

FIG. 1 is a block diagram illustrating a system for education in augmentation reality according to an embodiment of the present invention.

Referring to FIG. 1, a system 100 for education in augmentation reality (AR) according to the embodiment of the present invention includes an instructor terminal 110 of an instructor configured to, in order to guide learning and/or training (hereinafter referred to as training) of a learner on site or remotely using AR content, identify a training process of the learner and dynamically generate training support information required for the training, an AR service providing server 135 configured to manage an instructor and learners participating in the training process using AR content at the request of the instructor, and in order to effectively use a space for the training process using the AR content, analyze a training space in which the instructor is located and a training space in which the learner is located, and at least one learner terminal 155 configured to receive training information and display the received training information and transmit, to the AR service providing server 135, content training information which is information about a result obtained by performing the training process.

The instructor terminal 110 of the system 100 for education in AR according to the embodiment of the present invention is a terminal used by an instructor who provides training, and may include a camera unit 115 for photographing a virtual object and a training space for an AR service, a communication unit 120 for a network connection and data communication with the AR service providing server 135 and the learner terminal 155, an AR processing unit 125 for performing spatial analysis, training process identification, object state information generation, and the like, and a storage unit 130 for storing information about a user, such as a learner. The instructor terminal 110 may be in the form of a smartphone, in the form of a virtual reality device, or in the form of including both of a smartphone and a virtual reality device.

The camera unit 115 of the instructor terminal 110 may be a single or stereo camera, or a camera for measuring a depth, or a camera for acquiring a red-green-blue (RGB) image or a depth image.

The communication unit 120 of the instructor terminal 110 is a communication module that wirelessly transmits or receives data to or from the AR service providing server 135 and the learner terminal 155, and performs wireless data transmission and reception using communication technologies, such as Bluetooth, Wi-Fi, and mobile communication.

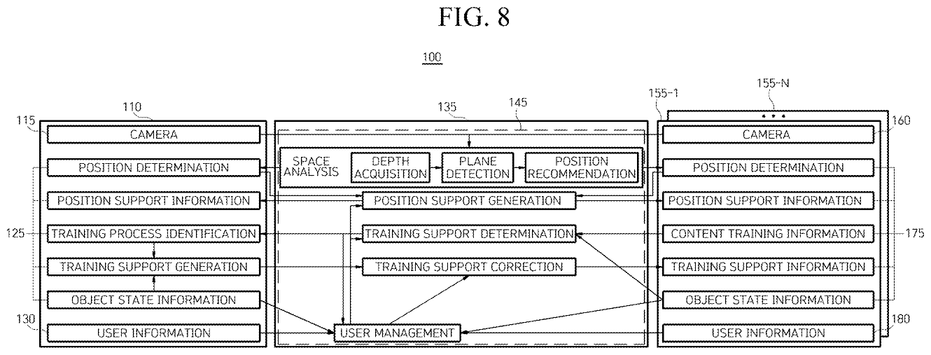

The AR processing unit 125 of the instructor terminal 110 determines a training execution start position for performing training based on spatial analysis information from the AR service providing server 135 as illustrated in FIG. 8.

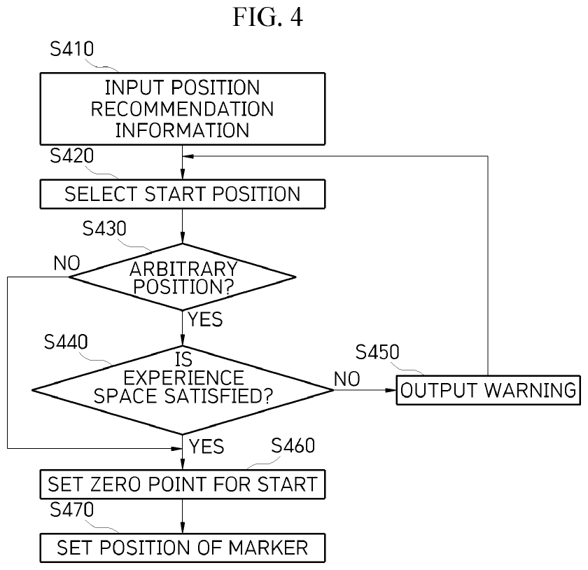

The determination of the training start position, as illustrated in FIG. 4, includes, upon receiving position recommendation information based on spatial analysis of the AR service providing server 135 (S410), selecting, by the instructor, a training execution start position (S420). When the selected training execution start position is an arbitrary position (YES in S430), a test is performed on an AR experience space, and when the AR experience space is satisfied (YES in S440), the selected training execution start position is set as a starting origin (S460) and the position of an AR marker is set (S470). When the AR experience space is not satisfied (NO in S440), a warning is output through a warning window (S450), and the selection of the training execution start position is performed again to newly find a suitable training execution start position (S420).

When the selected training execution start position is not an arbitrary position (NO in S430), the selected training execution start position is set as the starting origin (S460), and the position of an AR marker is set (S470).

To this end, the AR processing unit 125 of the instructor terminal 110 may receive, from the AR service providing server 135, position support information which is information about a specific point in a space that needs to be located in order to provide AR-based training, and guide the instructor to stand or sit in the position. An AR marker may be output and arranged at the determined start position or a portion adjacent to the determined start position.

The AR processing unit 125 of the instructor terminal 110 may receive information about learners having a low training performance ability from the AR service providing server 135 to identify a training process. By identifying the training process, the AR processing unit 125 may identify a training performance score of each learner, and allow the degree of performance of the corresponding learner to be displayed in three dimensions.

The AR processing unit 125 of the instructor terminal 110 may dynamically generate training support information that allows learners to pass a specific training stage. That is, the instructor may demonstrate how to perform a corresponding training stage using the instructor terminal 110, and in this case, collect state information (which is managed in “object state information” to be described below) of the instructor terminal 110, a success criterion of the training stage, and the like, and use the collected information and criterion to generate training support information. For example, while performing a car sharing job training, a photograph training for a specific part may be required to check the state of a vehicle, and in this case, the instructor may move while carrying the instructor terminal 110 to dynamically generate training support information including a proportion occupied by a specific partial object (e.g., a headlight, an instrument panel, etc.) in a vehicle, that is, a vertical object, when the specific partial object is photographed, or a movement (vertical and lateral movements, an angle change, etc.) of the instructor terminal 110 in the three-dimensional space.

The AR processing unit 125 of the instructor terminal 110 may generate object state information of the instructor terminal 110. The object state information of the instructor terminal 110 may include hardware (HW) information, such as a field of view (FOV), a focus, a zoom state, and a device unique ID being used by the instructor terminal 110; and state information of the instructor terminal 110, such as a position and an angle for tracking the instructor terminal 110 in three dimensions on the basis of coordinates defined in “position determination” based on a result of training space analysis by the AR service providing server 135.

The storage unit 130 of the instructor terminal 110 may store user information including an ID for distinguishing a user including a learner and an instructor, and user physical specificity information, such as a height, for considering a part in which the same motion may be expressed differently in an AR training process

The AR service providing server 135 of the system 100 for education in AR according to an embodiment of the present invention includes a communication unit 140 for a network connection and data communication with the instructor terminal 110 and the learner terminal 155, an AR processing unit 145 for performing spatial analysis, position support generation, training support determination, training support correction, and user management, and a storage unit 150 for storing information about a user, such as an instructor and a learner. The communication unit 140 of the AR service providing server 135 is a communication module that wirelessly transmits or receives data to or from the communication unit 120 of the instructor terminal 110 and the learner terminal 155, and performs wireless data transmission and reception using communication technologies, such as Bluetooth, Wi-Fi, mobile communication, and the like.

The AR processing unit 145 of the AR service providing server 135 receives captured images (including a training space image) from the camera units of the instructor terminal 110 and the learner terminal 155 and performs spatial analysis of performing a depth acquisition process, a plane detection process, and a position recommendation process and generating space generation recommendation information suitable for performing AR content.

In the depth acquisition process, a stereo technique may be applied to multiple RGB images or a deep learning model may be applied to a single RGB image, and depth information may be acquired from an image directly captured by a camera for depth acquisition. In the plane detection process, an area corresponding to the floor may be detected from the acquired depth information.

To this end, pixels are extracted at regular intervals from the acquired depth information, a vertical vector and a horizontal vector are obtained from nearby pixels of the pixel, a normal vector is generated through cross product, the degrees of similarity between the normal vectors represented at each position are compared, clustering is performed on areas adjacent to each other. In this case, areas belonging to the same clustering may be determined as one plane, and a portion having the widest area among the acquired planes may be detected to be a plane.

The position recommendation process as illustrated in FIG. 4 includes identifying a spatial minimum area required for training and providing recommended information suitable for a training start position to be set, and when the minimum area is not secured, determining whether there is an obstacle and inducing movement to a wide place or removing an obstacle to secure the minimum area.

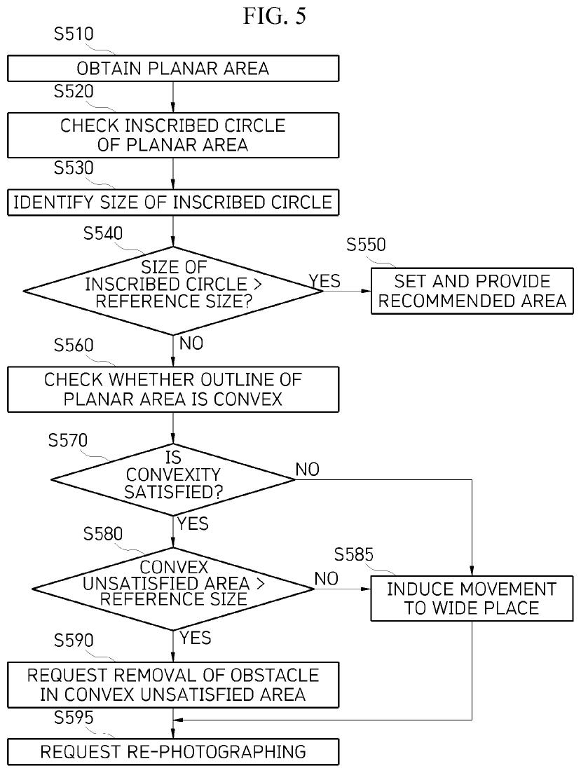

The AR processing unit 145 of the AR service providing server 135 according to an embodiment of the present invention, in order to set a recommended area for position recommendation, first includes obtaining a planar area in a planar area detection process (S510), and then checking an inscribed circle having a certain size in the obtained planar area (S520) as in a method of generating recommended space area information according to an embodiment of the present invention shown in FIG. 5. Thereafter, the size of an area that satisfies the inscribed circle is identified (S530), and when the size of the identified area is larger than a reference size (YES in S540), a recommended area is set and provided to the instructor terminal 110 and the learner terminal 155.

When the size of the identified area is smaller than or equal to the reference size (NO in S540), whether the outline of the planar area is convex is checked (S560), and when the outline is convex (YES in S570), movement to a wide place is induced (S585)) so that the instructor terminal 110 and/or the learner terminal 155 are requested to perform re-photographing (S595), and when the outline is not convex (NO in S570), it is determined that the size of the convex unsatisfied area is larger than a reference size (a reference size with respect to an inscribed circle), and when the convex unsatisfied area is larger than the reference area (YES in S580), removal of an obstacle in the convex unsatisfied area is requested (S590) to request the instructor terminal 110 and/or the learner terminal 155 to perform re-photographing (S595).

When the convex unsatisfied area is smaller than a reference size (a reference size with respect to a convex area) (NO in S580), movement to a wider place is induced (S585) to request the instructor terminal 110 and/or the learner terminal 155 to perform re-rephotographing (S595).

The AR processing unit 145 of the AR service providing server 135 according to the embodiment of the present invention may receive input about position information about a position selected by an instructor or a learner, the number of participants participating in an AR training process, and state information of an instructor terminal and a learner terminal, which are being used, to set a start position for each user that may be simultaneously utilized by a plurality of users (an instructor and a trainee), and to this end, may generate position support information for each user.

For example, in order to minimize an overlapping between users at a training site, when four users participate in a training, the users may be arranged at a 90-degree interval, and when six users participate in a training, the users may be arranged at 60-degree intervals. In addition, in order that the entire appearance of an AR virtual object used for training is output to the instructor terminal and the learner terminal, the distance from the position of an AR marker may be calculated according to the FOV and zoom state of each of the instructor terminal and the learner terminal to set a user-specific start position (while generating user-specific position support information).

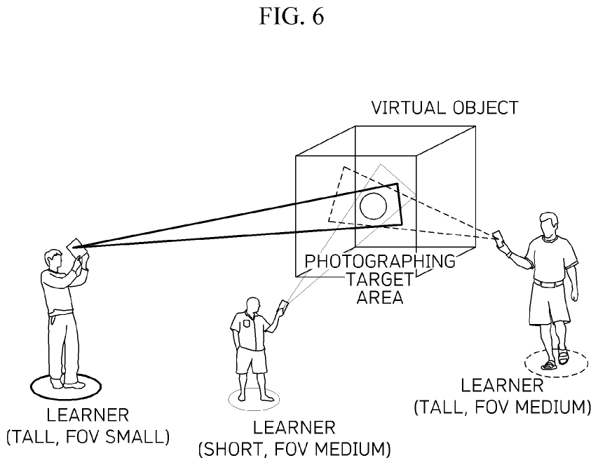

The AR processing unit 145 of the AR service providing server 135 according to the embodiment of the present invention sets a variable training performance criterion, evaluates a performance level of a learner, and determines whether there is a need to provide training support information for a learner who falls behind in training progress. The variable training performance criterion may be to set a training success criterion with various conditions according to the physical specificities (also referred to as physical characteristics) of the learner or the learner terminal, which is being used, to achieve a specific training goal. As an example, in the case of training for photographing a specific object, a basic success condition is photographing at a specific position and a specific angle, but as illustrated in FIG. 6 which is a conceptual diagram illustrating setting of a variable training performance criterion according to a user state in an AR education method according to an embodiment of the present invention, the variable training performance criterion may be provided be to set a training success criterion (an object inclusion ratio, whether a specific part of an object is included, etc.) different between users to include user specificities (the height, terminal specificities, etc.) as well as the position and angle, which is the basic success condition.

The AR processing unit 145 of the AR service providing server 135 according to the embodiment of the present invention uses an object photographing proportion, a number of photographing attempts, a photographing required time of a learner measured in a training performance level of a trainee, an average number of photographing attempts and average photographing required time for each individual, a degree of approach to a target position, a change in object photographing proportion, and a previous training record of the learner, to determine whether training performance support information needs to be provided.

For example, when evaluating a training performance level of a trainee and providing training support information, a target time of a learner required for each stage may be initially set from previous training records of the learner, and for evaluating the training performance level of each learner, a trainee position is tracked at certain time intervals within the corresponding time, the distance between the trainee position and a target position and is quantified to evaluate the training performance level, and the proportion of an object to be photographed when object photographing is attempted may be measured and converted to a target achievement level, which may be used as a basis for determining the training performance level.

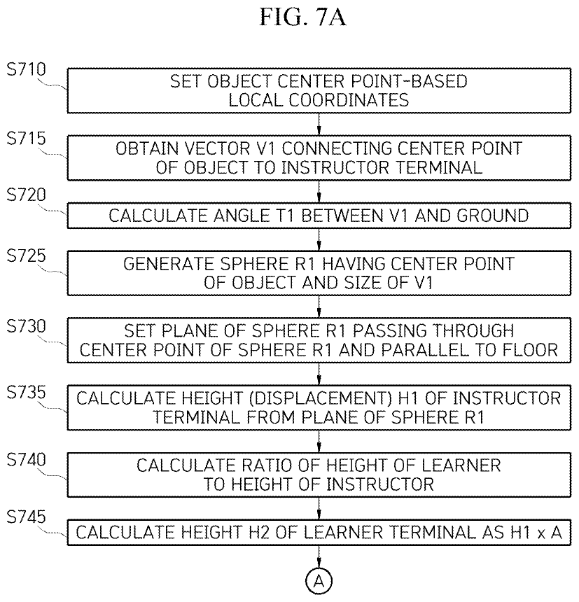

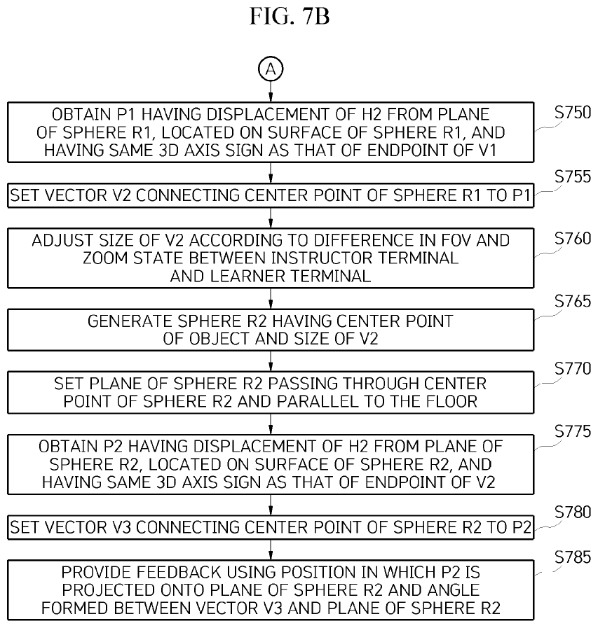

The AR processing unit 145 of the AR service providing server 135 according to the embodiment of the present invention may correct instructor training support information as illustrated in FIG. 7A and FIG. 7B, which is a flowchart showing a method of correcting instructor training support information in the AR education method according to an embodiment of the present invention.

The correction of the instructor training support information is a process in which training support information generated by an instructor through an instructor terminal is generated as customized training support information based on physical specificities, such as the learner's height, and characteristics of the individual learner terminal used for training. The AR processing unit 145 of the AR service providing server 135 may simultaneously provide learners who need customized training support information with the generated customized training support information.

As shown in FIG. 7A and FIG. 7B, when correcting the training support information generated by the instructor, two spheres are generated according to projection information and a vector size of an object and instructor vector or an object and trainee vector to provide trainee customized feedback. By utilizing a position adjacent to the projection information, feedback on a position may be provided to the learner, and through information about the direction of the vector, feedback on the angle of a learner terminal that drives AR content may be provided.

Specifically, object center point-based local coordinates are set (S710), a vector V1 connecting the center point of an object to an instructor terminal is obtained (S715), and an angle T1 between the vector V1 and the ground is calculated (S720). Next, a sphere R1 having the center point of the object and the size of V1 is generated (S725), a plane of the sphere R1 passing through the center point of the sphere R1 and parallel to the floor is set (S730) to calculate a height H1 (a displacement) of the instructor terminal from the plane of the sphere R1 (S735), the ratio A of the height of the learner to the height of the instructor is calculated (S740), a height H2 of the learner terminal is calculated as H1×A (S745). Then, P1 having a displacement of H2 from the plane of the sphere R1, located on the surface of the sphere R1, and having the same 3D axis sign as that of an endpoint of the vector V1 is obtained (S750), and a vector V2 connecting the center point of the sphere R1 to P1 is set (S755), the size of the vector V2 according to the difference in FOV and zoom state between the instructor terminal and the learner terminal is adjusted (S760), and a sphere R2 having the center point of the object and the size of the vector V2 is generated (S765), a plane of the sphere R2 passing through the center point of the sphere R2 and parallel to the floor is set (S770), P2 having a displacement of H2 from the plane of the sphere R2, located on the surface of the sphere R2, and having the same 3D axis sign as that of an endpoint of the vector V2 is obtained (S775), a vector V3 connecting the center point of the sphere R2 to P2 is set (S780), and feedback using the position in which P2 is projected onto the plane of the sphere R2 and the angle formed between the vector V3 and the plane of the sphere R2 is provided (S785).

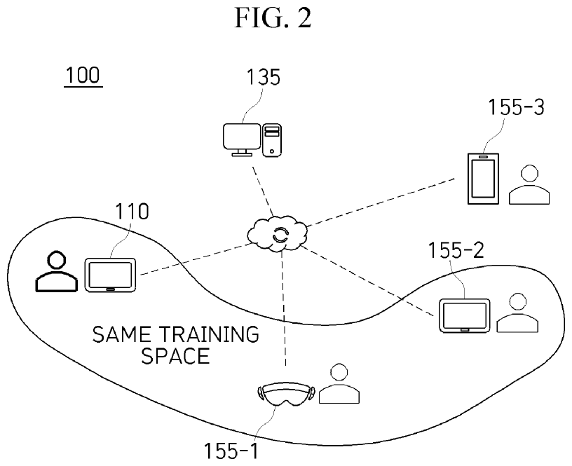

The AR processing unit 145 of the AR service providing server 135 according to the embodiment of the present invention may perform matching such that the instructor and the learner performing or participating in a training on site or remotely may utilize AR content of the same training process, and manage sessions (referred to as user management). That is, while the learner may be located in the same training space as that of the instructor (in the case of 155-1 and 155-2 in FIG. 2) or may be located in a space different from that of the instructor (in the case of 155-3 in FIG. 2) as illustrated in FIG. 2, which is a conceptual diagram illustrating a system for education in AR according to an embodiment of the present invention, the AR processing unit 145 of the AR service providing server 135 according to an embodiment of the present invention may allow even a trainee (155-3 in FIG. 2) on a remote site to be remotely provided with AR content using technology, such as a cloud system, such that the remote trainee may participate in a training of the instructor.

In addition, the AR processing unit 145 of the AR service providing server 135 according to the embodiment of the present invention may collect user information of an instructor and a learner and object state information, accumulate and manage training performance level evaluation information of the learner, and use the information for effective spatial arrangement and for training support correction to correct training evaluation and support information.

The storage unit 150 of the AR service providing server 135 according to an embodiment of the present invention may store the user information of the instructor and the learner and the object state information in the form of files or databases, which may be managed to be accessible by the AR processing unit 145 of the AR service providing server 135.

The learner terminal 155 of the system 100 for education in AR according to the embodiment of the present invention is a terminal used by a learner, who is trained, and configured to provide the AR service providing server 135 with content learning information, which is information obtained by performing an AR content-based training process, and when the training performance is not satisfied, receive customized training support information dynamically generated by the instructor in real time to perform the corresponding training process. The learner terminal 155 may be in the form of a smartphone, in the form of a virtual reality device, or in the form of including both of a smartphone and a virtual reality device.

The learner terminal 155 includes a camera unit 160 for photographing a virtual object and a training space for an AR service, a communication unit 170 for a network connection and data communication with the AR service providing server 135 and the instructor terminal 110, an AR processing unit 175 for supporting AR training, and a storage unit 180 for storing training support information and object state information.

The camera unit 160 of the learner terminal 155 may be a camera for acquiring input data for generating a training space in which AR content is to be output and proceeding with training, and may be a single or stereo camera, or a camera for measuring depth, or a camera for acquiring an RGB image or a depth image.

The communication unit 170 of the learner terminal 155 is a communication module that wirelessly transmits or receives data to or from the AR service providing server 135 and the instructor terminal 110, and performs wireless data transmission and reception using communication technologies, such as Bluetooth, Wi-Fi, and mobile communication.

The AR processing unit 175 of the learner terminal 155 determines a training execution start position for performing training based on spatial analysis information from the AR service providing server 135 as illustrated in FIG. 8.

When the training execution start position is determined, the training execution start position of a trainees (155-1 and 155-2 in FIG. 2) in the same space as that of the instructor may be determined by the instructor, and information about the training execution start position may be provided to the learner terminal 155, and a trainee (155-3 in FIG. 2) participating in training remotely may select one area from among positions recommended by the AR service providing server 135 to determine the training execution start position. In this case, an AR marker may be disposed at the determined training execution start position or a portion adjacent to the determined training execution start position, and an independent virtual object for each individual learner may be generated and output from the marker.

The AR processing unit 175 of the learner terminal 155 may receive the training execution start position generated from the AR service providing server 135 in the form of training execution position support information.

The AR processing unit 175 of the learner terminal 155 may generate content training information including information (referred to as training execution stage information) about a stage at which training is performed and including reference information about a success and a failure of the training execution and may provide the generated content training information to the AR service providing server 135. The training execution stage information may include the position, size, rotation, shape, and form of a main virtual object used in the training process, the type of an execution operation used in the training process, and the like. The AR service providing server 135 having received the training execution stage information may use the training execution stage information as information for identifying a training performance level of the learner and determining customized training support.

The AR processing unit 175 of the learner terminal 155 may receive corrected training support information from the AR service providing server 135. That is, when customized training support information generated according to the specificities of the learner by the instructor terminal 110 of the instructor is transmitted to the AR service providing server 135, the learner terminal 155 receives, from the AR service providing server 135, the customized training support information, and visualizes AR content, which is not properly performed by the learner, based on the received customized training support information, for the learner to perform the AR content In this case, the specificities of the learner include a training ability (a training ability of the learner identified by the instructor terminal based on the content training information received by the instructor terminal) of the learner and physical information, such as the height of the learner.

The AR processing unit 175 of the learner terminal 155 may generate object state information which is state information of the learner terminal 155. The object state information of the learner terminal 155 may include HW information, such as a FOV, a focus, a zoom state, and a device unique ID being used by the learner terminal 155; and state information of the learner terminal 155, such as a position and an angle for tracking the learner terminal 155 in three dimensions on the basis of coordinates defined in “position determination.”

The storage unit 180 of the learner terminal 155 may store user information including an ID that may distinguish a user and user physical specificity information, such as the height, for considering a part in which the same motion may be expressed differently in an AR training process.

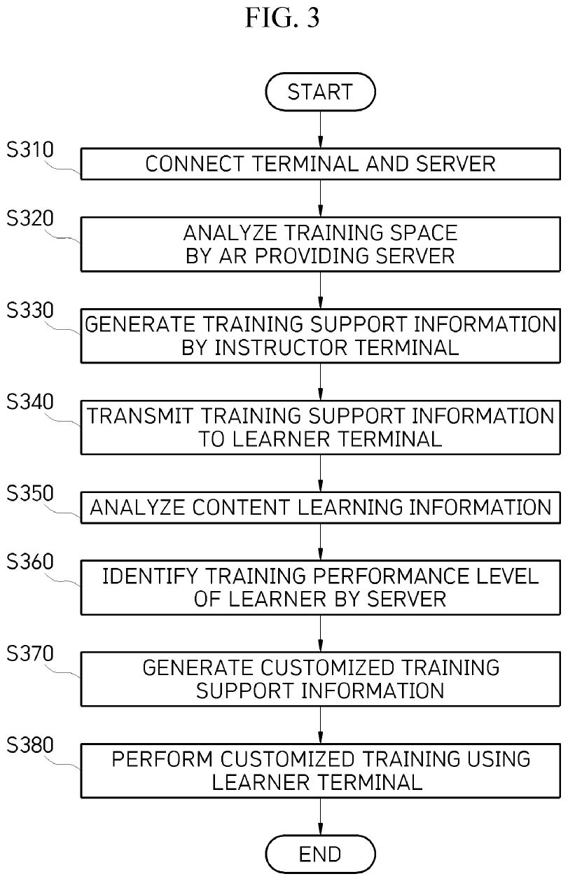

FIG. 3 is a flowchart showing a method of providing an AR service according to an embodiment of the present invention.

Referring to FIG. 3, the method of providing an AR service according to the embodiment of the present invention is an embodiment of an operation implemented, when AR content based on a mixed real and virtual environment is used in a training process in a face-to-face and non-face-to-face environment using the system for education in AR according to the embodiment of the present invention shown in FIGS. 1 and 2, such that an instructor provides training and education to a plurality of learners through the same virtual object for the plurality of learners to be simultaneously provided with training content and customized training guide suitable for the position of the learner regardless of the type of a device used by the learner and physical characteristics of the learner.

A network connection is established between the instructor terminal 110, the learner terminal 155, and the AR service providing server 135 (S310). In this case, a plurality of connected learner terminals 155 may be provided, and may be learner terminals of learners present in a space that is the same as or different from that of the instructor terminal 110.

The AR service providing server 135 analyzes training spaces of the instructor terminal 110 and the learner terminal 155 based on space images provided by the instructor terminal 110 and the learner terminal 155 (S320). According to a result of the analysis, training execution start positions of the instructor and the learner are determined, and the determined training execution start positions are provided to the instructor terminal 110 and the learner terminal 155 (which may also be referred to that the training execution start positions of the instructor terminal and the learner terminal are determined).

After the training execution start position is determined, the instructor terminal 110 generates training support information for the learner (S330). The generated training support information is transmitted to the learner terminal 155 through the AR service providing server 135 (S340). In this case, when the learner terminal is provided in plural, the training support information generated based on object state information of each learner terminal may be transmitted to the corresponding learner terminal.

When the training support information is generated, the instructor terminal 110 may generate the training support information based on at least one of an object photographing proportion, a number of photographing attempts, a photographing required time, a degree of approach to a target position, a change in object photographing proportion, and a previous training record of the learner.

The learner terminal 155 transmits content training information, which is information about a result of performing the training, to the AR service providing server 135, and the AR service providing server 135 analyzes the content training information (S350).

Through the analysis, the AR service providing server 135 identifies the training performance level of the learner (S360). When identifying and evaluating the training performance level of the learner, the AR service providing server 135 may set a variable training performance criterion that is determined by at least one of physical specificities and device specificities of the learner terminal 155 in consideration of a training goal achievement, and identify and evaluate the training performance level of the learner based on the set variable training performance criterion.

The identified training performance level of the learner is transmitted to the instructor terminal 110 so that the instructor may identify the degree to which the corresponding learner is trained to generate training support information suitable for the level or state of the learner (S370) (in this case, the training support information is referred to as customized training support information).

When generating the customized training support information, the AR service providing server 135 may evaluate the training performance level of the learner based on the variable training performance criterion set for each learner terminal 155 to generate the customized training support information.

The generated customized training support information is transmitted via the AR service providing server 135 to the learner terminal 155, and the learner performs customized training based on the transmitted customized training support information using the learner terminal 155 (S380).

The above embodiments may be implemented using various types of computing devices including one or more processors, memories, and storage devices, and may also include a network interface connected to a wired or wireless network. The above-described components perform data communication through a data communication bus. The processor may be a central processing unit (CPU) or a semiconductor device that executes processing instructions stored in a memory and/or a storage unit. The memory and the storage unit may include a volatile storage medium or a non-volatile storage medium. For example, the memory may include a read only memory (ROM) or a random-access memory (RAM).

In addition, operations of a method or algorithm described with reference to the embodiments disclosed herein may be implemented directly in a hardware module executed by the processor, implemented in a software module, or implemented in a combination thereof. Software modules may reside in a RAM, a flash memory, a ROM, an Erasable Programmable ROM (EPROM), an Electrically Erasable Programmable ROM (EEPROM), a register, a hard disk, a removable disk, a CD-ROM, or any other form of storage medium.

An illustrative storage medium may be coupled to a processor such that the processor reads information from, or writes information to, the storage medium. Alternatively, the storage medium may be integrated into the processor. The processor and the storage medium may reside in an application specific integrated circuit (ASIC). The ASIC may reside in a user terminal. Alternatively, the processor and the storage medium may reside as separate components in a user terminal.

As is apparent from the above, according to the present invention, when an instructor performs an education through the same virtual object on a plurality of learners using AR content based on a mixed real and virtual environment for an education or training process in a face-to-face or non-face-to-face environment, the learner can be simultaneously provided with education content and a user-customized guide suitable for the position of the learner regardless of the type of the device used by the learner or the physical characteristics of the learner.

In addition, according to the present invention, space setting required for utilization of AR content is automatically provided through space recognition, so that the convenience of using AR content in the actual education field can be increased.

Although the constructions of the present invention have been described in detail with reference to embodiments, the embodiments should be regarded as illustrative rather than limiting in all aspects. A person of ordinary skill in the art should appreciate that various modifications and equivalents derived from the suggestion and the teaching of the above specification fall within the scope and sprit of the present invention. For example, the AR processing unit 125 and the storage unit 130 of the instructor terminal 110 may be implemented by being integrated into one module or divided into two or more devices. Therefore, the scope of the present invention is defined by the appended claims of the present invention.

What is claimed is:

1. A system for education in augmented reality (AR), the system comprising:
an instructor terminal configured to, in order to guide training of at least one learner on site or remotely using AR content, identify a training process of the trainee and generate training support information which is support information required for performing the training;
an AR service providing server configured to manage the instructor terminal and a learner terminal that participate in the training using the AR content based on a request of the instructor terminal, and in order to derive a training space used in the training process, analyze a training space in which the instructor terminal is located and a training space in which the learner terminal is located; and
at least one learner terminal configured to transmit, to the AR service providing server, content training information which is a result obtained by the learner performing the training based on the training support information.

2. The system of claim 1, wherein the instructor terminal is configured to identify a training performance level of the learner based on the content training information received from the AR service providing server, and generate customized training support information for the learner based on at least one of a specificity of the learner terminal of the learner and a specificity of the learner.

3. The system of claim 2, wherein the specificity of the learner includes at least one of a training performance level of the learner and a physical specificity of the learner.

4. The system of claim 1, wherein the AR service providing server is configured to analyze the training space based on a training space image transmitted by at least one of the instructor terminal and the learner terminal.

5. The system of claim 4, wherein the instructor terminal and the learner terminal are configured to receive training execution start position information generated based on the space analysis by the AR service providing server.

6. The system of claim 1, wherein the AR service providing server is configured to evaluate a training performance level of the learner based on a variable training performance criterion determined by at least one of a specificity of the learner terminal of the learner and a physical specificity of the learner to achieve a training goal of the learner.

7. The system of claim 1, wherein the training support information is generated by the instructor terminal based on at least one of an object photographing proportion, a number of photographing attempts, a photographing required time, a degree of approach to a target position, a change in object photographing proportion, and a previous training record of the learner.

8. A method of education in augmented reality (AR), the method comprising:
analyzing, by an AR service providing server, a training space in which an instructor terminal is located and a training space in which a learner terminal is located;
determining, by the AR service providing server, training execution start positions of the instructor terminal and the learner terminal based on a result of the analyzing of the training spaces;
after the determining of the training execution start positions, generating, by the instructor terminal, training support information which is support information required for performing training on a learner, and transmitting the generated training support information to the AR service providing server;
transmitting, by the AR service providing server, the received training support information to the learner terminal; and
transmitting, by the learner terminal, content training information, which is a result obtained by the learner performing the training based on the training support information, to the AR service providing server,
wherein the learner performs the training using the learner terminal.

9. The method of claim 8, further comprising:
transmitting, by the AR service providing server, the received content training information to the instructor terminal;
generating, by the instructor terminal, customized training support information for the learner based on the content training information; and
transmitting, by the instructor terminal, the generated customized training support information to the AR service providing server.

10. The method of claim 8, wherein the analyzing, by the AR service providing server, of the training space in which the instructor terminal is located and the training space in which the learner terminal is located includes analyzing, by the AR service providing server, the training space based on a training space image transmitted by at least one of the instructor terminal and the learner terminal.

11. The method of claim 8, further comprising:
generating, by the AR service providing server, information about the training execution start position based on the analyzing of the training space; and
transmitting, by AR service providing server, the generated information about the training execution start position to the instructor terminal and the learner terminal.

12. The method of claim 9, wherein the generating of the customized training support information for the learner includes evaluating, by the AR service providing server, a training performance level of the learner based on a variable training performance criterion that is set for each learner terminal.

13. The method of claim 12, wherein the evaluating of the training performance level of the learner includes:
setting, by the AR service providing server, the variable training performance criterion determined by at least one of a physical specificity of the learner and a device specificity of the learner terminal in consideration of training goal achievement; and
evaluating, by the AR service providing server, the training performance level of the learner based on the set variable training performance criterion.

14. The method of claim 8, wherein the generating of the training support information includes generating, by the instructor terminal, training support information based on at least one of an object photographing proportion, a number of photographing attempts, a photographing required time, a degree of approach to a target position, a change in object photographing proportion, and a previous training record of the learner.
